(19) United States
(12) Patent Application Publication
(10) Pub. No.: US 2021/0243079 A1
(43) Pub. Date: Aug. 5, 2021

(54) BI-DIRECTIONAL COMMISSIONING FOR LOW-POWER WIRELESS NETWORK DEVICES

(71) Applicant: SIGNIFY HOLDING B.V., EINDHOVEN (NL)

(72) Inventor: Mingqian HAN, EINDHOVEN (NL)

(21) Appl. No.: 16/972,787

(22) PCT Filed: Jun. 24, 2019
(86) PCT No.: PCT/EP2019/066692

§ 371 Date: Dec. 7, 2020

(30) Foreign Application Priority Data
Jun. 27, 2018 (CN) PCT/CN2018/093157
Aug. 30, 2018 (EP) 18191796.4

(51) Int. Cl. H04L 12/24; H04W 4/80; H04L 29/08; H04W 24/02

(52) U.S. Cl. CPC H04L 41/0806; H04W 4/80; H04W 84/20; H04W 24/02; H04L 67/28

(57) ABSTRACT

The present invention relates to methods and apparatuses for controlling commissioning of low-power devices in a wireless network by using at least two proxy devices, wherein a destination device selects from the at least two proxy devices a working proxy device and non-selected proxy devices enter a silence mode for a predetermined time period. The destination device stores an information indicating a previously selected working proxy device for quick reuse and more efficient selection.

### FIELD OF THE INVENTION

The invention relates to the field of commissioning of low-power network devices in wireless networks, such as but not limited to green power devices in Zigbee networks, for use in various different applications for home, office, retail, hospitality and industry.

### BACKGROUND OF THE INVENTION

Zigbee networks represent another type of a low-power/low-cost wireless networks which allow multi-hop communication among devices in a mesh topology. Zigbee devices offer reduced power consumption and cost, together with mesh networking capability, which make them suitable for use in large-scale deployments. Examples of application of Zigbee mesh networks include home automation, building automation, retail services, smart energy, and wireless indoor lighting systems.

During initial setup, a Zigbee device performs a commissioning procedure to obtain a network key used to encrypt communication between devices in the network. Commissioning is a process in which a new Zigbee network is set up or a new Zigbee device is added to an existing network.

A so-called green power device (GPD) is a kind of low-power Internet of Things (IoT) device. Typically, a green power device consumes very limited power energy, and sometimes it can be battery-less and just harvests energy from human operations. This makes green power devices suitable where mains or battery operations is not possible or practicable. On technical details, green power devices operate with a compact stack above the IEEE 802.15.4 Media Access Control (MAC) and Physical (PHY) layers, as compared with traditional ZigBee devices.

Due to the low power operation of green power devices, they must use a very compact frame format and need to be proxied by ZigBee devices to ZCL frames to be propagated within a ZigBee network. This kind of ZigBee devices are generally called green power proxies (GPP) and the used kind of green power tunneling is described in ZigBee document 14-0563-16 (ZigBee PRO Green Power feature specification, Basic functionality set, Version 1.0).

For the green power device to be usable across a traditional ZigBee network, it needs to talk to the green power proxy using the ZigBee network operating channel. Basically, as described in ZigBee document 14-0563-16, there are two ways to tell the green power device the ZigBee operating channel:

1) bi-directional commissioning: in bi-directional commissioning, a green power device which can receive radio communication, upon commissioning will issue channel request commands on all channels and wait for a channel configuration response from some ZigBee device (which is called temporary master (TempMaster) according to ZigBee document 14-0563-16). The payload of the channel configuration response contains the ZigBee operating channel information.

2) uni-directional commissioning: in uni-directional commissioning, usually the green power device is unable to receive radio communication, e.g., due to the fact that it is battery-less. When this kind of green power device is to be commissioned, it sends out commissioning commands on a specific user selected channel, e.g., by pushing some specific button combination for sending on a specific channel.

In chapter A.3.6.2.3 (“TempMaster election”), the specification (i.e. ZigBee document 14-0563-16) defines a method to elect a temporary master from several candidate responders during green power (GP) bi-directional commissioning. However, in chapter A.3.3.4.3 (GP commissioning notification command), the specification (i.e. ZigBee document 14-0563-16) also defines that all proxy basic devices shall set a bidirectional communication capability to “0b0”. So, when a GP sink (GPS) is in the GP commissioning mode, the temporary master can only be elected by a GPP-GPD link value contained in the GP commissioning notification message based on the following criteria:

1) The highest GPP-GPD link value;

2) Among same GPP-GPD link values, the highest received signal strength indicator (RSSI) value;

3) Among same GPP-GPD link values, the lowest short address.

But in practice, appointing only one temporary master sometimes affects robustness of the communication between GP devices and GP proxies. So, it is better to appoint multiple temporary masters during GP commissioning, to thereby improve reliability. This is also recommended by the specification (i.e. ZigBee document 14-0563-16), as indicated in chapter A.3.9.1 (“GP commissioning The procedure”).

However, appointing multiple temporary masters leads to the following problems. Since the specification does not clarify the procedure to appoint multiple temporary masters, it is usually up to the implementation. Some implementations (e.g. EmberZNet from SiliconLabs) just appoint each GP proxy as the temporary master. On one hand, at some time each temporary master will switch its channel, making it inaccessible temporarily by other ZigBee nodes. On the other hand, after switching the channel, different temporary masters simply send a GP data frame (GPDF) to the GP device without carrier-sense multiple access with collision avoidance (CSMA/CA), which is a network multiple access method in which carrier sensing is used, but nodes attempt to avoid collisions by transmitting only when the channel is sensed to be “idle”. Due to the fact that the order of communication is not aligned, the behavior may create significant collisions which lead to a non-reliable GP communication. In large scale, high density networks, this obviously impacts ZigBee network stability and performance.

### SUMMARY OF THE INVENTION

It is an object of the present invention to provide a reliable commissioning approach for low-power network devices in wireless networks.

This object is achieved by a system as claimed in claim 1, by an apparatus as claimed in claim 5 or 11, by a method as claimed in claim 13 or 14, and by a computer program product as claimed in claim 15.

According to a first aspect, a system for controlling commissioning of a network node in a wireless network is provide, wherein the system comprises at least two proxy devices for forwarding commissioning messages through the network; and a destination device adapted to select from the at least two proxy devices a working proxy device for forwarding a commissioning response in the wireless network in response to the receipt of a channel request from the network node and to inform the at least two proxy devices about the selected working proxy device; wherein the at least two proxy devices are adapted to enter a silence mode for a predetermined time period if they are not selected as working proxy device.

Accordingly, reduced network traffic can be achieved, especially in large scale network, since proxies other than the assigned working proxy will enter into a silent mode for the predetermined time period. Moreover, the serial appointment of the working proxy by the destination device once at a time and one by one effectively avoids possible communication collisions.

In one embodiment of the present invention, the wireless network is a Zigbee network, the network node is a green power device, the destination device is a green power sink device and the working proxy is a working proxy device accordingly.

It is noted that the present invention can be applied to a general wireless network, in which a network node seeks to be commissioned to a destination device and the network node and the destination device communicate via proxy devices. E.g., green power device is based on IEEE 802.15.4 wireless protocol, the commissioning procedures of present invention can also be applied to commission a network node in a Thread mesh network, which is also based on IEEE802.15.4. For devices other than green power ones, and with other mesh networking for example BLE mesh, the invention can also be used to optimize its commissioning procedure and network performance, by inhibiting certain wireless communications (for example in BLE mesh certain beacons) and decrease certain conflicts and retries.

According to a first option of the first aspect, the destination device may be adapted to store an identification of the selected working proxy device and to use the stored identification for subsequent commissioning messages. Thereby, the working proxy device can be selected faster. The destination device records the identification (e.g. a short address) of the selected working proxy device and may thus reuse it to tunnel all communications between the network node, e.g. a GP device and the destination e.g. a GP sink device during the whole commissioning phase (e.g. GP commissioning reply) to thereby achieve a quicker selection.

According to a second option which may be combined with the first option of the first aspect, the destination device may be adapted to disregard a proxy device which corresponds to the stored identification in a subsequent selection of a working proxy device. Thereby, smarter avoidance can be achieved, so that once the selected working proxy device doesn't work, the selected one will not be selected again next time.

According to a third option which may be combined with the first or second option of the first aspect, the destination device may be adapted to clear the stored identification information when all of the at least two proxy devices have been selected and tried as working proxy during a commissioning procedure. Thereby, a new full selection of proxy devices is available after the last one has been tried.

According to a second aspect, an apparatus is provided for controlling commissioning of a network node at a destination device in a wireless network, wherein the apparatus is adapted to select from at least two proxy devices a working proxy device for forwarding a commissioning response in the wireless network, in response to the receipt of a channel request from the network node and to inform the at least two proxy devices about the selected working proxy device.

According to a first option of the second aspect, the apparatus is adapted to apply at least one of the following criteria for selection of the working proxy device:
the highest link value contained in a commissioning notification message;
among same link values, the highest received signal strength indicator;
among same link values, the lowest short address.

Using at least one of the above criteria provides an easy and straight forward approach for a reliable selection of the working proxy device.

According to a second option which can be combined with the first option of the second aspect, the apparatus may be adapted to control the destination device so as to add an identification of the selected working proxy device to the commissioning response and to broadcast or unicast the commissioning response to the at least proxy devices. Thereby, the proxy devices can be reliably informed about the selected working proxy device.

According to a third option which can be combined with the first or second option of the second aspect, the apparatus may be adapted to store an identification of the selected working proxy for subsequent commissioning messages or for use in a subsequent selection of a working proxy device. This measure allows faster and more reliable selection of the working proxy device in subsequent commissioning signaling.

According to a fourth option which can be combined with any of the first to third options of the second aspect, the apparatus may be adapted to disregard a proxy device which corresponds to the stored identification in a subsequent selection a working proxy device. This measure allows to improve the pool of proxy devices from which selection the working proxy device can be selected in subsequent commissioning signaling.

According to a fifth option which can be combined with any of the first to fourth options of the second aspect, the apparatus may be adapted to clear the stored identification information when all of the at least two proxy devices have been selected and tried as working proxy during a commissioning procedure. Thereby, the entire pool of proxy devices is available for selection when all of them have been successively tried.

According to a third aspect, an apparatus for controlling a proxy device in a wireless network is provided, wherein the apparatus is adapted to set the proxy device into a silence mode for a predetermined time period in response to a receipt of an information from a destination device that the proxy device has not been selected as working proxy device for a commissioning procedure.

According to a first option of the third aspect, the apparatus may be adapted to terminate the predetermined time period in response to a receipt of a channel request from the network device. This measure provides the advantage that all proxy devices are available again when it is assumed the all channels have been traversed.

According to a fourth aspect, a method of controlling commissioning of a network node at a destination device in a wireless network is provided, wherein the method comprises selecting from at least two proxy devices a working proxy device for forwarding a commissioning response in the wireless network, in response to the receipt of a channel request from the network node; and informing the at least two proxy devices about the selected working proxy device.

According to a fifth aspect, a method of controlling a proxy device in a wireless network is provided, wherein the apparatus is adapted to set the proxy device into a silence mode for a predetermined time period in response to a receipt of an information from a destination device that the proxy device has not been selected as working proxy device for a commissioning procedure.

Finally, according to a sixth aspect, a computer program product is provided, which comprises code means for producing the steps of the above methods according to the fourth or fifth aspects when run on a computer device.

It is noted that the above apparatuses may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the system, the apparatuses, the methods, and the computer program product of the above aspects may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows a schematic system architecture of a wireless lighting network with proxy devices;

FIG. 2 shows a schematic processing and signaling diagram for a commissioning procedure according to a first embodiment;

FIG. 3 shows a flow diagram of a commissioning procedure at a sink device according to a second embodiment; and

FIG. 4 shows flow diagram of a commissioning procedure at a proxy device according to a second embodiment.

### DETAILED DESCRIPTION OF EMBODIMENTS

Embodiments of the present invention are now described based on a Zigbee network as an example of a wireless network and GP commissioning as an example of a commissioning approach for low-power devices.

The GP feature allows battery-less Zigbee products such as sensors, switches, dimmers and many others to securely join Zigbee networks. These devices can now be powered just by using widely available, but often missed sources of energy like motion, light, or vibration, to name a few. For example, GP may take advantage of the energy used to flip a typical light switch via common energy harvesting techniques, which is powerful enough send commands through a Zigbee network. By creating proxies in a Zigbee router device, each Zigbee GP device is represented as always present on the Zigbee network—even when it is not powered on or present. These proxies forward and resend packets to ensure reliable communication, especially to destination devices, called sinks, that are not in the direct radio range of the Green Power device.

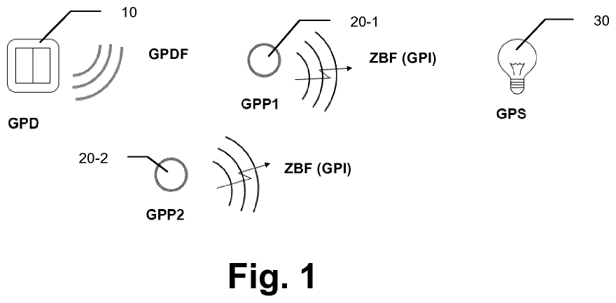

FIG. 1 shows a schematic architecture of a multi-hop Zigbee lighting network in which embodiments of the present invention can be implemented. The network comprises at least one luminaire device 30 (e.g. a smart lamp such as a light emitting diode (LED) based lamp, gas-discharge lamp or filament bulb, plus any associated support, casing or other such housing) arranged to emit illumination in into an environment. The environment may be an indoor space such as one or more rooms and/or corridors of a building; or an outdoor space such as a park, garden, road, or outdoor parking area; or a partially covered space such as a stadium, structured parking facility or gazebo; or any other space such as an interior of a ship, train or other vehicle; or any combination of such possibilities. The luminaire device 30 may take any suitable form such as a ceiling or wall mounted luminaire, a free-standing luminaire, a wall washer, a chandelier; or a less conventional form such as embedded lighting built into an item of furniture, a building material such as glass or concrete, or any other surface.

The luminaire device 30 is equipped with a wireless communication interface allowing it to be controlled remotely by lighting control commands received from a user device (not shown) such as a smartphone, tablet, laptop or desktop computer, or by a GP device (GPD) 10 which many be a wireless switch device (e.g., a wall switch) 10, and/or based on sensor readings received from one or more remote sensors (not shown).

According to FIG. 1, the luminaire device 30 acts as a GP sink (GPS) during GP commissioning and is supported by first and second Zigbee devices 20-1 and 20-2 which act as respective GP proxies GPP1 and GPP2. The GP device 10 sends out a GP device frame (GPDF) and the GP proxies 20-1 and 20-2 generate based thereon respective Zigbee frames (ZPF(GPI)) carrying GP information to be forwarded to the GP sink 30.

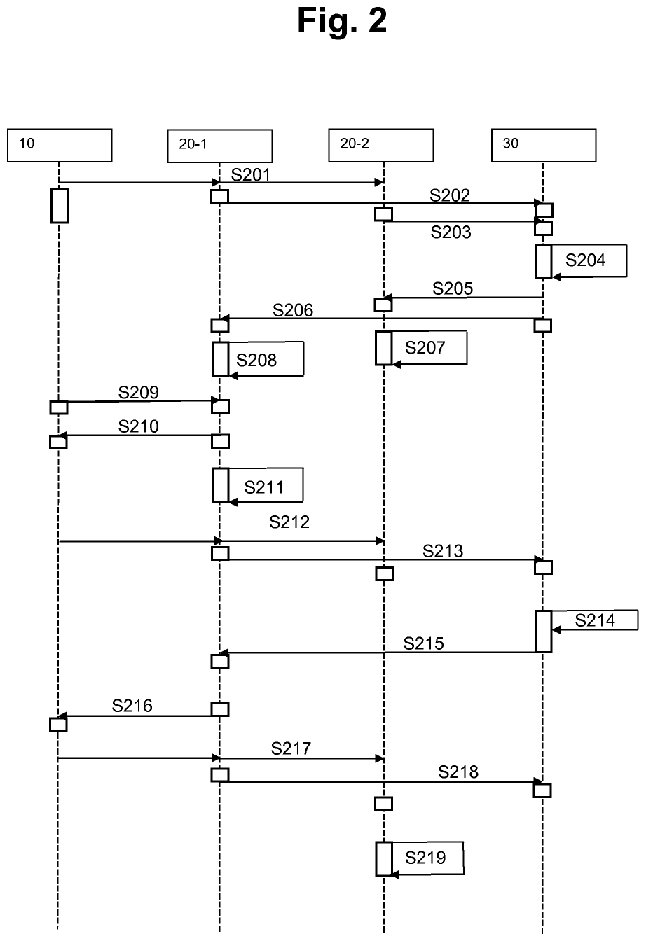

In the following, a GP commissioning procedure, which can be implemented in the network architecture of FIG. 1, is described with reference to FIG. 2.

FIG. 2 shows a processing and signaling diagram of a GP commissioning procedure according to a first embodiment, where multiple temporary masters can be appointed during GP commissioning. The diagram of FIG. 2 is to be interpreted in a sense that the upper blocks represent network devices (i.e. GP device 10, GP proxies 20-1, 20-2 and GP sink 30) that participate in the procedure, horizontal arrows represent signaling messages, and rectangles represent processing step(s) at the network device to which the corresponding vertical dotted line leads, while time passes along the dotted lines from the upper to the lower part of the diagrams of FIG. 2.

Initially, the GP device 10 broadcasts a GP channel request on a first channel (Ch A) to the first GP proxy 20-1 and to the second GP proxy 20-2 (step S201). In response thereto, the first and second GP proxies 20-1 and 20-2 send in steps S202 and S203 respective commissioning notification messages whose payload is a channel request to the GP sink 30. If required, further requests may be sent on at least one other channel.

Within a predetermined time period Dmax (e.g. 100 ms) after the reception of the GP commissioning notification message whose payload is the channel request, the GP sink 30 selects in step S204 the best GP proxy (i.e. the first GP proxy 20-1 in the present example) as the as temporary master using the criteria mentioned above.

Then, in steps S205 and S206, the GP sink 30 sends a GP response message whose payload comprises a channel configuration information and an information (e.g. short address) indicating the selected temporary master information to the GP proxies 20-1 and 20-2, respectively. Steps S205 and S206 may be performed as single step, if the GP sink broadcasts or multicasts the GP response to both GP proxies 20-1 and 20-2 at a time. At the same time, the GP sink 30 locally stores the information (e.g. short address) which indicates the selected temporary master to remember the selected temporary master.

Upon receiving the GP response, the non-selected GP proxies (i.e. the second GP proxy 20-2 in the present example) will internally mark itself as silent to enter into a silent mode and start a silent time window in step S207, which means that it will stop GP tunneling to reduce traffic. Furthermore, the selected GP proxy (i.e. the first GP proxy 20-1 in the present example) sends out in step S210 a corresponding GP data frame with the channel configuration information to the GP device 10, without CSMA/CA.

It is noted that the GP specification states that the GP data frame sent to the GP device 10 needs to be sent 20-25 ms after the triggering frame sent by this GP device 10. However, in case of commissioning a GP data frame with a parameter RxAfterTx set to “0b1”, the GP commissioning notification is sent the earliest at 30 ms after that GP data frame. Thus, forwarding for commissioning GP data frame number N may still be ongoing when commissioning GP data frame number N+1 (and the possible intended response) is sent. The GP specification tries to limit the risk by recommending at least 500 ms time spacing between consecutive GP data frames with RxAfterTx parameter.

Moreover, it is noted that the present commissioning procedure applies to unicast GP commissioning notifications (as opposed to the broadcast GP commissioning notifications), where the decision is up to the GP sink 30 and communicated to the GP proxies 20-1 and 20-2 in a GP Proxy Commissioning Mode message, opening the commissioning mode.

Optionally, prior to step S210, the selected first GP proxy 20-1 may switch to another channel (Ch B) in step S208 and may receive a GP channel request from the GP device 10 in step S209. In this case, the GP data frame with the channel configuration information is sent on the other channel (Ch B). Thereafter, in step S211, the selected first GP proxy 20-1 may switch back to the first channel (Ch A). This channel switching operation may be needed because the GP device 10 may send the next channel request on another channel (i.e. Ch B) and expects the channel configuration reply on that channel. This new channel request (shown in step S209) is however not received by the second GP proxy 20-2 because it is on another channel. If, however, the second GP proxy 20-2 does receive a new channel request on the first channel (Ch A), it should reset its silence time window, because this indicates that the GP device 10 has tried all possible channels and tries this channel for a second time.

If the GP device 10 successfully receives the channel configuration information, it then transmits in step S212 a commissioning GP data frame to the first and second GP proxies 20-1 and 20-2. However, this commissioning GP data frame will only be tunneled in step S213 by the selected temporary master (i.e. the selected first GP proxy 20-1 in the present example) to the GP sink 30 as a GP commissioning notification message, because all silent GP proxies (i.e. the second GP proxy 20-2 in the present example) will not tunnel it, so that the network is cleaner.

Upon receipt of the GP commissioning notification message whose payload is the GP commissioning information (i.e. GP data frame), the GP sink 30 uses in step S214 the remembered temporary master information as the selection to respond with a commissioning reply in step S215, so that it can react faster.

As an alternative option, the GP sink 30 may be arranged to send the GP response message in unicast to a selected proxy (i.e. selected temporary master). To accommodate for that case, the GP proxies might also put themselves in the silence mode, if they do not receive any GP response message within a predetermined time period following the channel request.

The commission reply will be forwarded in step S216 by the selected temporary master (i.e. the first GP proxy 20-1 in the present example) to the GP device 10. In response thereto, the GP device 10 send in step S217 a GP success message to the first and second GP proxies 20-1 and 20-2, while again this commissioning GP data frame will only be tunneled in step S218 by the selected temporary master (i.e. the selected first GP proxy 20-1 in the present example) to the GP sink 30 as a GP commissioning notification message.

When the silence time window of the non-selected GP proxies (i.e. the second GP proxy 20-2 in the present example) expires in step S219, they will return to their normal behavior and will tunnel received GP data frames.

However, if after step S210, the GP device 10 fails to receive the channel configuration information, it will retry the attempt by sending again the channel request. The channel request GP data frames will immediately trigger all silence time windows at the non-selected GP proxies to expire, because when a new channel request is received, this means that the GP device 10 has traversed all other channels.

Upon the receipt of GP commissioning notifications whose payload is channel request, the GP sink 30 again selects the best GP proxy as temporary master using the criteria above but avoids selection of previous temporary master (i.e. the first GP proxy 20-1 in the present example). The GP sink 30 then updates the stored temporary master information based on the current selection. This procedure is repeated until the GP device 10 has successfully configured itself to a ZigBee operating channel.

If all GP proxies have been tried, then the remembered temporary master information is cleared and the whole procedure is started again with all available GP proxies.

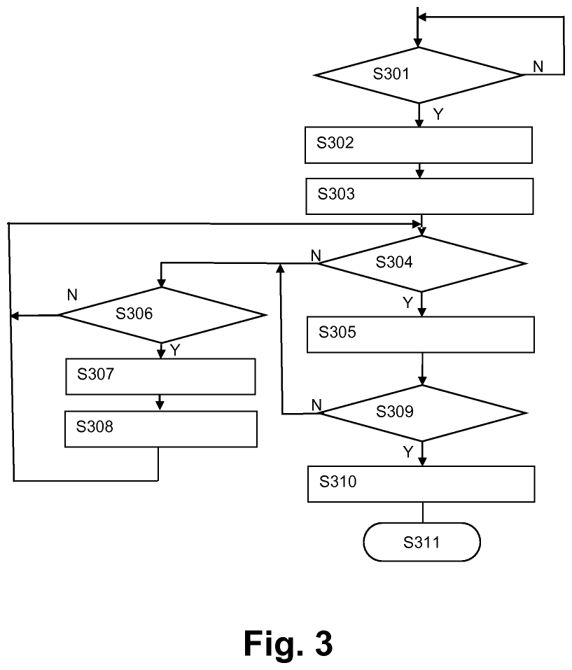

In the following, a commissioning control procedure at a GP sink device (e.g. GP sink 30 of FIG. 1) according to a second embodiment is described with reference to a flow diagram shown in FIG. 3.

In step S301, the procedure initially waits until a commissioning process has been triggered by an external event (e.g. activation of a trigger button, receipt of a commissioning instruction etc.) and waits for a commissioning notification with channel request.

If receipt of such a notification has been determined, the procedure proceeds to step S302 and a temporary master is selected from available GP proxies e.g. based on the initially mentioned criteria. Then, in step S303, an information indicating the selected temporary master is stored and a GP response message with the temporary master information and channel configuration information is broadcast or unicast to the GP proxies.

In the next step S304, the procedure checks whether a GP commissioning notification with a GP commissioning GP data frame has been received. If so, the procedure continues with step S305 and the stored temporary master information is used to respond via the remembered GP proxy. Then, the procedure continues with step S309 where it is checked whether a GP commissioning frame with GP success information has been received within a predetermined time period. If so, the procedure proceeds to step S310 where a successful commissioning is determined and then ends at step S311.

Otherwise, if it is determined in step S309 that no commissioning notification with GP success information has been received, or in step S304 that no GP commissioning notification with GP commissioning GP data frame has been received, the procedure branches to step S306 and checks whether a commissioning notification with channel request has been received. If so, the procedure continues with step S307 and the procedure selects the best GP proxy as new temporary master while disregarding previously remembered temporary master(s). If all available GP proxies have been selected, then the previously remembered temporary master information is cleared so that all GP proxies are available for selection as temporary master. Based on the new selection, the stored temporary master information is updated and a GP response message with the updated temporary master information and channel configuration information is broadcast or unicast to the GP proxies in step S308. Thereafter, the procedure jumps back to step S304 and checks whether a commissioning notification with GP commissioning request has been received.

If it is determined in step S306 that no commission notification with channel request has been received, the procedure also jumps back to step S304 and checks whether a commissioning notification with GP commissioning GP data frame has been received.

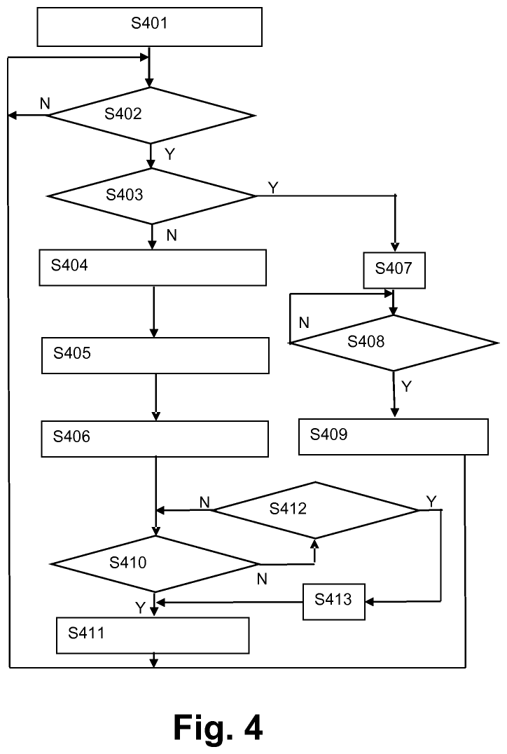

In the following, a commissioning control procedure at a GP proxy device (e.g. first or second GP proxies 20-1 or 20-2 of FIG. 1) according to a third embodiment is described with reference to a flow diagram shown in FIG. 4.

In an initial step S401, a commissioning notification with GP channel request is received from a GP device (e.g. GP device 10 of FIG. 1) and forwarded to a GP sink device (e.g. GP sink 30 in FIG. 1). Then, the procedure waits in step S402 until a GP response with temporary master information has been received from the GP sink. If such a response has been received, the procedure proceeds to step S403 and it is checked whether the GP proxy itself has been selected as temporary master. If not, a temporary silence mode is entered for the duration of a predetermined silence mode window in step S404. Then, the GP tunneling is stopped in step S405 and a timer operation for counting the duration of the silence mode window is started in step S406. Then, the procedure proceeds to step S410 and it is checked whether the timer for counting the silence mode window has expired. If so, the GP tunneling function is reactivated in step S411. If not, the procedure branches to step S412 and it is checked whether a GP channel request has been received. If so, the timer of the silence mode window is reset in step S413 so that the silence mode window has no expired. Then, the procedure continues with step S411 and the GP tunneling function is reactivated.

If it is determined in step S412 that no GP channel request has been received, the procedure continues with step S410.

After step S411, the procedure jumps back to the initial step S401 and waits for a new GP response.

If it is determined in step S402 that the GP proxy itself has been selected as temporary master, then an GP data frame with channel configuration information is sent to the addressed GP device in step S407 and the procedure proceeds to step S408 where it waits for the receipt of a GP commissioning data frame. If such a GP commissioning data frame has been received from the GP device, the procedure continues with step S409 and the GP commissioning data frame is tunneled to the GP sink. Then, the procedure jumps back to the initial step S401 and waits for a new GP response.

The above embodiments offer a fast and reliable GP commissioning procedure especially for large networks. The proposed commissioning procedures can be implemented in other types of wireless networks and for other typed of low-power network devices.

To summarize, methods and apparatuses have been described for controlling commissioning of low-power devices in a wireless network by using at least two proxy devices, wherein a sink device selects from the at least two proxy devices a temporary master device and non-selected proxy devices enter a silence mode for a predetermined time period. The sink device stores an information indicating a previously selected temporary master device for quick reuse and more efficient selection.

While the invention has been illustrated and described in detail in the drawings and foregoing description, such illustration and description are to be considered illustrative or exemplary and not restrictive. The invention is not limited to the disclosed embodiments. The proposed commissioning procedures can be applied to and possibly standardized in other types of multi-hop networks and with other types of messages and control fields. Moreover, the invention can be applied in any product that implements a wireless network (e.g. Zigbee or others). The present invention is equally applicable to (low-power) network devices of any other wireless technology (e.g. BLE, Infrared (IR), near field communication (NFC), wireless local area communication (Wi-Fi)) with a second wireless (e.g. multi-hop) technology (e.g. Zigbee PRO, Thread, WirelessHART, SmartRF, CityTouch, IP500, and any other mesh or tree-based technology).

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

A single unit or device may fulfill the functions of several items recited in the claims. The mere fact that certain measures are recited in mutually different dependent claims does not indicate that a combination of these measures cannot be used to advantage.

The described operations like those indicated in FIGS. 2 to 4 can be implemented as program code means of a computer program and/or as dedicated hardware of the commissioning device or luminaire device, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. A system for controlling commissioning of a network node, which is a Green Power node in a Zigbee network, wherein the system comprises:
at least two proxy devices for forwarding commissioning messages through the network; and
a sink device adapted to select from the at least two proxy devices a temporary master device for forwarding a commissioning response in the wireless network in response to the receipt of a channel request from the network node and to inform the at least two proxy devices about the selected temporary master device;
wherein the at least two proxy devices are adapted to enter a silence mode not tunneling commissioning responses from the sink device to the network node for a predetermined time period if they are not selected as temporary master devices; and the sink device is further adapted to disregard a proxy device which corresponds to the stored identification in a subsequent selection of a temporary master device.

2. The system of claim 1, wherein the sink device is adapted to store an identification of the selected temporary master device and to use the stored identification for subsequent commissioning messages.

3. The system of claim 2, wherein the sink device is adapted to clear the stored identification information when all of the at least two proxy devices have been selected and tried as temporary master devices during a commissioning procedure.

4. (canceled)

5. An apparatus for controlling commissioning of a network node at a sink device in a wireless network, wherein the apparatus is adapted to select from at least two proxy devices a temporary master device for forwarding a commissioning response in the wireless network, in response to the receipt of a channel request from the network node and to inform the at least two proxy devices about the selected temporary master device; and the apparatus is further adapted to disregard a proxy device which corresponds to the stored identification in a subsequent selection of a temporary master device.

6. The apparatus of claim 5, wherein the apparatus is adapted to apply at least one of the following criteria for selection of the temporary master device:
the highest link value contained in a commissioning notification message;
among same link values, the highest received signal strength indicator;
among same link values, the lowest short address.

7. The apparatus of claim 5, wherein the apparatus is adapted to control the sink device so as to add an identification of the selected temporary master device to the commissioning response and to broadcast or unicast the commissioning response to the at least proxy devices.

8. The apparatus of claim 5, wherein the apparatus is adapted to store an identification of the selected temporary master for subsequent commissioning messages or for use in a subsequent selection of a temporary master device.

9. The apparatus of claim 5, wherein the apparatus is adapted to clear the stored identification information when all of the at least two proxy devices have been selected and tried as temporary master during a commissioning procedure.

10. A method of controlling commissioning of a network node at a sink device in a wireless network, wherein the method comprises
selecting from at least two proxy devices a temporary master device for forwarding a commissioning response in the wireless network, in response to the receipt of a channel request from the network node; and
informing the at least two proxy devices about the selected temporary master device;
wherein the method further comprising
disregarding a proxy device which corresponds to the stored identification in a subsequent selection of a temporary master device.

11. The method of claim 10, wherein the method comprises applying at least one of the following criteria for selection of the temporary master device:
the highest link value contained in a commissioning notification message;
among same link values, the highest received signal strength indicator;
among same link values, the lowest short address.

12. The method of claim 10, wherein the method further comprises controlling the sink device so as to add an identification of the selected temporary master device to the commissioning response and to broadcast or unicast the commissioning response to the at least proxy devices.

13. The method of claim 10, wherein the method further comprises storing an identification of the selected temporary master working proxy for subsequent commissioning messages or for use in a subsequent selection of a temporary master device.

14. The method of claim 13, wherein the method further comprises clearing the stored identification information when all of the at least two proxy devices have been selected and tried as temporary master during a commissioning procedure.

15. A computer program product comprising code means for producing the steps of claim 10 when run on a computer device.
